(19) United States
(12) Patent Application Publication
(10) Pub. No.: US 2025/0073877 A1
(43) Pub. Date: Mar. 6, 2025

(54) OPTIMIZED NAIL GUN FIRING STRUCTURE

(71) Applicants: Zhonghua Jiang, Taizhou (CN); Xiaopeng Li, Taizhou (CN); Fazheng Yang, Taizhou (CN)

(72) Inventors: Zhonghua Jiang, Taizhou (CN); Xiaopeng Li, Taizhou (CN); Fazheng Yang, Taizhou (CN)

(21) Appl. No.: 18/460,598

(22) Filed: Sep. 4, 2023

(51) Int. Cl. B25C 5/16

(52) U.S. Cl. CPC B25C 5/1637; B25C 5/1617

(57) ABSTRACT

An optimized nail gun firing structure, which includes a magazine, a guide plate connected to the top of the magazine, a striking pin guided for linear reciprocating motion by the guide plate, and a cover assembly connected to the guide plate. The magazine comprises a fixed plate, a movable plate, and a magazine seat rigidly connected to the bottom of the movable plate. A hook lock assembly forms a connection between the fixed plate and the magazine seat. Inside the magazine, a push plate is disposed, and a compression spring is configured between the push plate and the magazine seat, continuously pushing nails towards the guide plate. The guide plate comprises a separable first guide plate and a second guide plate. The first guide plate is connected to the fixed plate via fasteners, and the second guide plate is connected to the movable plate via fasteners.

### TECHNICAL FIELD

The present invention relates to an optimized nail gun firing structure.

### BACKGROUND ART

Nailing guns, commonly used in the construction and renovation industry, utilize compressed air or electric motors as a power source to drive a firing pin in linear reciprocating motion. The firing pin sequentially ejects nails from a nail magazine and fastens them to boards for connecting purposes. In existing nailing gun mechanisms, the nail ejection structure includes a nail magazine, a guide plate fixed to the top of the nail magazine, and a firing pin directed in linear reciprocating motion by the guide plate. The guide plate is an integral piece featuring an integrated nail separator. Inside the nail magazine, there is a pushing plate and a row of nails. The pushing plate uses spring force to push the row of nails towards the guide plate. For easier nail reloading, the nail magazine is generally designed with a fixed plate, a sliding plate relative to the fixed plate, and a magazine seat fixed below the sliding plate. The fixed plate is directly connected to the guide plate, and the fixed plate and the magazine seat are connected through a hook lock assembly. The guide plate, being an integral component, involves casting, machining, and heat treatment processes. During these processes, the integral guide plate and the nail separator are prone to bending and deformation, leading to lower product yields and higher manufacturing costs. Furthermore, the firing pin undergoes continuous impacts with the nail separator, which is a cantilevered component, making it susceptible to fracture and failure. This results in a limited lifespan for the guide plate, requiring periodic replacement of the fractured nail separator.

### SUMMARY OF THE INVENTION

To address the deficiencies in the existing technology, the present invention provides an optimized nailing gun nail firing structure.

In order to achieve the above objectives, the present invention provides an optimized nail gun firing structure comprising a magazine, a guide plate connected to the top of the magazine, a striking pin guided for linear reciprocating motion by the guide plate, and a cover assembly connected to the guide plate, wherein the magazine includes a fixed plate, a movable plate sliding relative to the fixed plate, and a magazine seat rigidly connected to a bottom of the movable plate, a hook lock assembly connects the fixed plate with the magazine seat; the magazine has a push plate disposed therein, a compression spring is configured between the push plate and the magazine seat to continually push nails towards the guide plate, the guide plate includes a separable first guide plate and a second guide plate, the first guide plate is connected to the fixed plate via fasteners, and the second guide plate is connected to the movable plate via fasteners, a square hole is disposed at a center of the first guide plate, and the second guide plate has an integral nail splitter which fits into the square hole to form a nail groove.

More preferably, wherein the hook lock assembly includes a hook pivotally connected to the magazine seat and an elastic element for resetting the hook, the hook secures to the fixed plate under the action of the elastic element.

More preferably, wherein the movable plate includes an integrally formed partition plate, which forms a U-shaped groove in an interior cavity of the magazine, a top of the U-shaped groove connects to the nail groove, and a cross-section of the push plate is U-shaped to fit the U-shaped groove.

More preferably, wherein the fixed plate has a vertically oriented guide channel, and the push plate has a protrusion that extends into the guide channel.

More preferably, wherein an inner wall of the fixed plate has multiple equally spaced first protrusions, and the partition plate has multiple equally spaced second protrusions, the position of the second protrusions corresponds to the first protrusions.

More preferably, wherein the cover assembly includes a fixed seat attached to one end of the first guide plate, a pressing plate pivotally connected to the fixed seat, a latch pivotally connected to a top of the pressing plate, and a spring hook rotatably connected to the latch, the spring hook secures to a hook portion of the first guide plate to apply pressure to the pressing plate against the first guide plate.

In the technical scheme described above, the cover assembly is designed to be flip-open. During the actual operation of the nail gun, nail jams may occur. By opening the flip-open cover assembly, these jams can be quickly addressed, ensuring the smooth progress of the nailing operation.

The beneficial effects of this utility model compared to existing technologies are as follows: The guide plate is designed as a separable first guide plate and second guide plate, making the manufacturing of the guide plate more convenient. During heat treatment, local deformation of the nail splitter is easily controlled, thus increasing the product's qualification rate. The second guide plate is connected to the movable plate. The integral nail splitter, which is formed with the second guide plate, has a certain amount of displacement during the continuous striking process of the striking pin, avoiding the breaking of the nail splitter due to continuous impact. This optimized nail gun firing structure thus ensures easier manufacturing, higher product yields, and prevents the breaking of the nail splitter, extending its lifespan.

### BRIEF DESCRIPTION OF THE DRAWINGS

FIG. 1 shows a three-dimensional view of an optimized nail gun firing structure involved in the present invention;

FIG. 2 is a schematic view of FIG. 1 with the movable plate hidden;

FIG. 3 shows another three-dimensional view of an optimized nail gun firing structure involved in the discussion;

FIG. 4 is a cross-sectional schematic view of the magazine;

FIG. 5 is a schematic view of the cover assembly;

FIG. 6 is a schematic view of the guide plate;

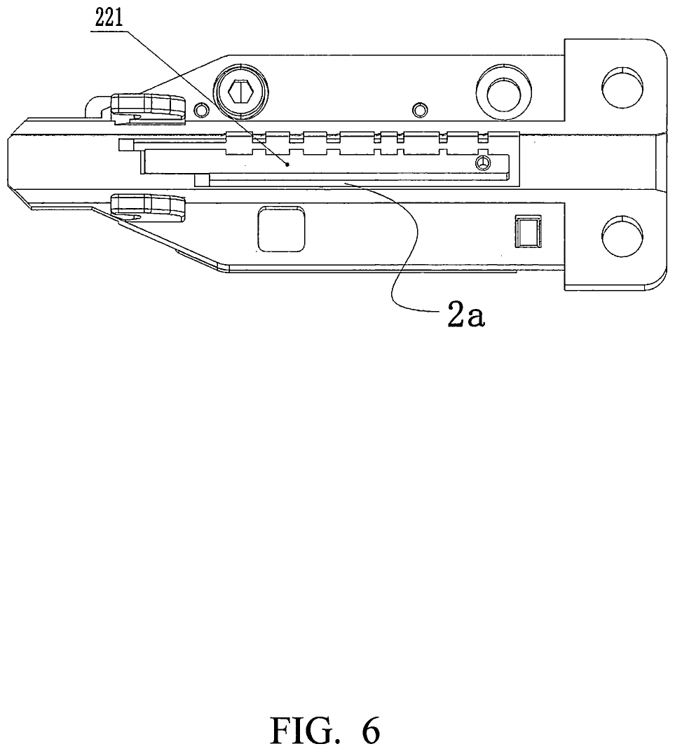

FIG. 7 is an exploded view of the guide plate;

FIG. 8 is a three-dimensional view of the push plate.

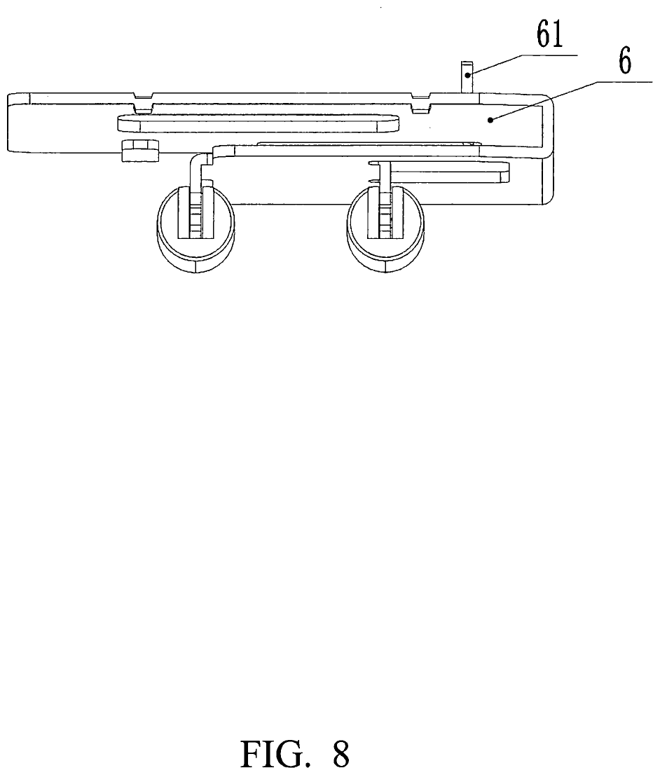

### DETAILED DESCRIPTION OF THE EMBODIMENTS

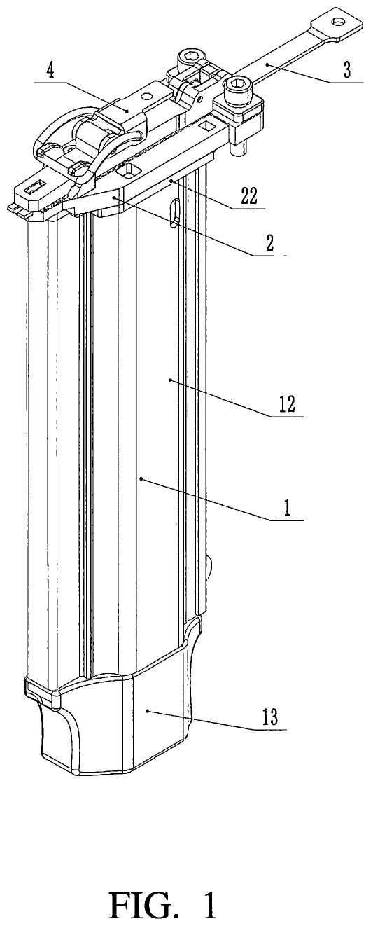

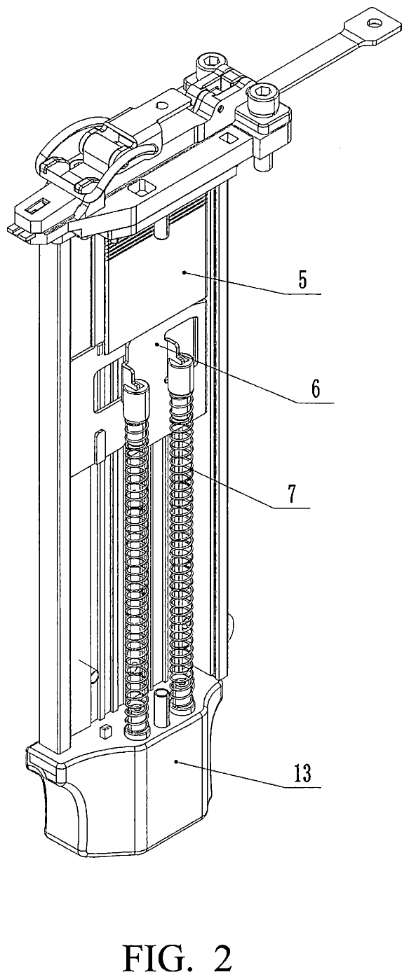

As shown in FIGS. 1 to 3, an optimized nail gun firing structure in an embodiment of the present invention comprises a magazine 1, a guide plate 2 connected to the upper part of the magazine 1, a striking pin 3 linearly reciprocating under the guidance of the guide plate 2, and a cover assembly 4 connected to the guide plate 2. The magazine 1 includes a fixed plate 11, a movable plate 12 sliding relative to the fixed plate 11, and a magazine seat 13 attached to the underside of the movable plate 12. The fixed plate 11 is connected to the magazine seat 13 through a hook lock assembly 8. A push plate 6 is housed within the magazine 1, biased by a compression spring 7 between it and the magazine seat 13, constantly pushing a row of nails 5 toward the guide plate 2.

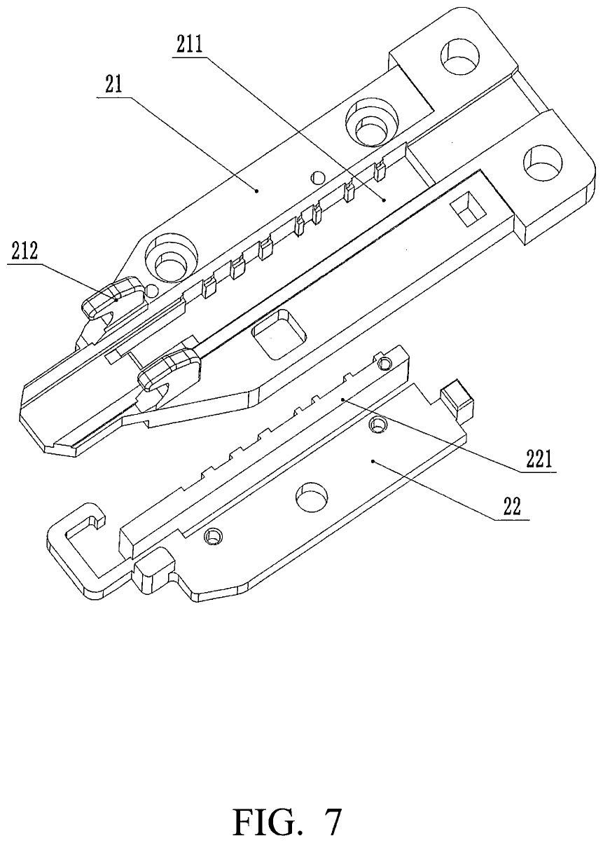

As shown in FIG. 7, the guide plate 2 comprises two separate parts: a first guide plate 21 and a second guide plate 22. The first guide plate 21 is fastened to the fixed plate 11, while the second guide plate 22 is fastened to the movable plate 12. The first guide plate 21 has a square hole 211, and the second guide plate 22 has an integral nail splitter 221 that fits into the square hole 211 to form a nail groove 2a.

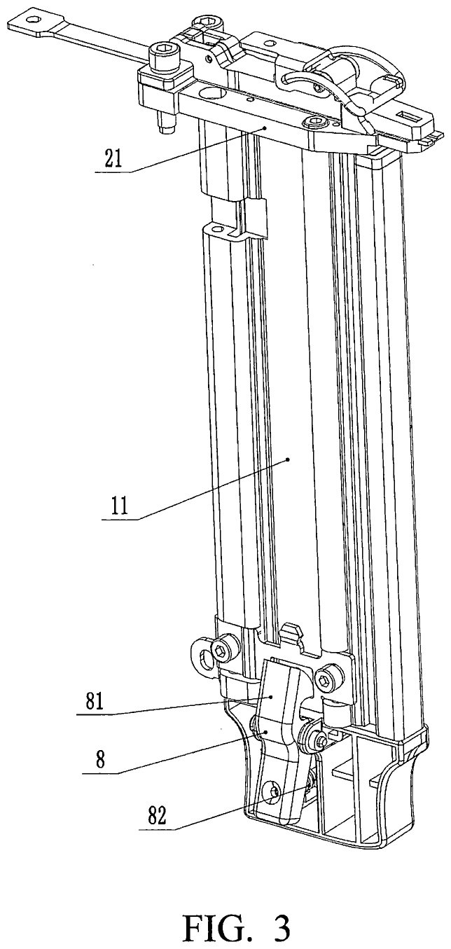

As shown in FIG. 3, the hook lock assembly 8 includes a hook 81 pivoted to the magazine seat 13 and an elastic element 82 for resetting the hook 81. The hook 81 hooks onto the fixed plate 11, securing the connection between the fixed plate and the magazine seat 13. By pressing the hook, the connection can be released, allowing easy replenishment of nails within the magazine 1.

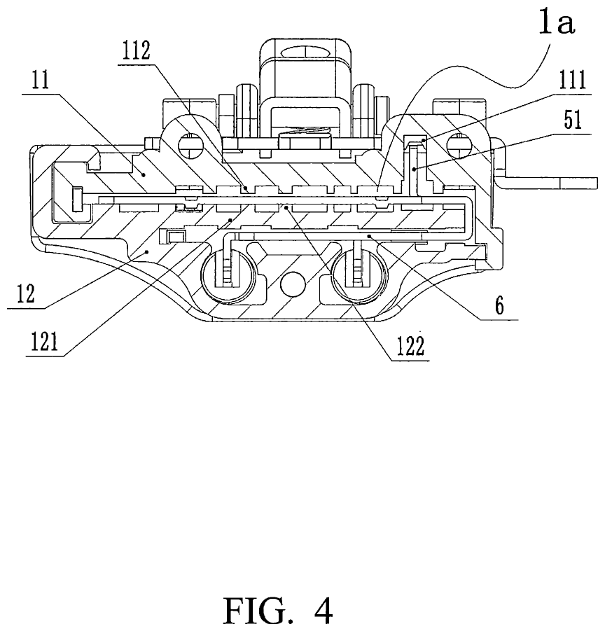

As shown in FIG. 4, the movable plate 12 has an integrally formed partition plate 121 which forms a U-shaped groove 1a inside the magazine 1, enabling the magazine 1 to accommodate U-shaped nails. The push plate 6 is also U-shaped to fit into this groove. A vertically oriented guide channel 111 is machined along the vertical direction of the fixed plate 11. Protrusions 61 extend from the push plate 6 into this guide channel 111, providing stable movement of the push plate 6.

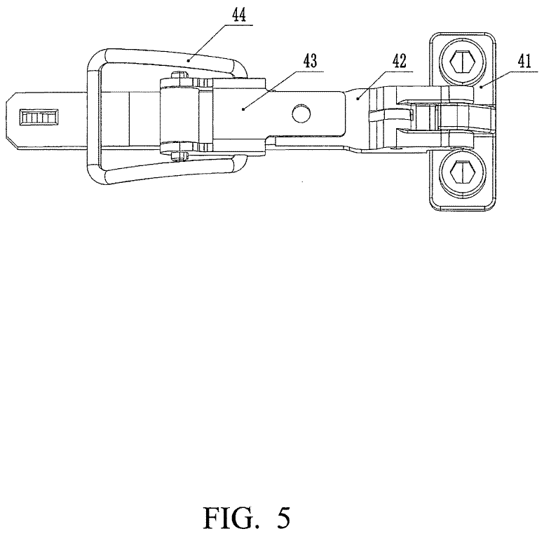

As shown in FIGS. 1 and 5, the cover assembly 4 comprises a fixed seat 41 fixed to the end of the first guide plate 21, a pressing plate 42 pivoted on the fixed seat 41, a latch 43 pivoted on the pressing plate 42, and a spring hook 44 rotatably connected to the latch 43. The spring hook 44 latches onto a hook portion 212 on the first guide plate 21, securing the pressing plate 42 to the first guide plate 21.

The guide plates are designed in two separate parts, making manufacturing easier. The second guide plate is connected to the movable plate, allowing some displacement, thus avoiding breakage due to continuous striking by the striking pin 3. This optimized nail gun firing structure is easier to manufacture, has a higher yield, and is less prone to breakage, thereby extending its lifespan.

During nailing, the compression spring 7 pushes the push plate 6 toward the guide plate 2. The topmost nail from the row of nails 5 reaches the nail groove 2a, and the reciprocating striking pin 3 fires the nails out one by one, achieving automatic nailing.

During nailing, the compression spring 7 pushes the push plate 6 towards the guide plate 2, causing the row of nails 5 to move along with the push plate 6. The topmost nail in the row reaches the position of the nail groove 2a, where the reciprocating striking pin 3 will successively drive the nails 5 out, achieving automatic nailing. The modular design of the guide plate 2 makes it easier to manufacture parts and control local deformations. Additionally, when the striking pin 3 strikes the integral nail splitter 221, it is connected to the movable plate 12 which has a certain degree of freedom. This avoids direct and repeated rigid impact on the integral nail splitter 221, preventing it from breaking.

The above description is merely a preferred embodiment of this invention and is not intended to limit it. For those skilled in the art, various modifications and changes can be made to this invention without departing from the spirit and principles of the invention. Any modifications, equivalent substitutions, and improvements made within the spirit and principles of the invention should be included within the scope of its protection.

I claim:

1. An optimized nail gun firing structure comprising
a magazine (1), a guide plate (2) connected to the top of the magazine (1), a striking pin (3) guided for linear reciprocating motion by the guide plate (2), and a cover assembly (4) connected to the guide plate (2),
wherein the magazine (1) includes a fixed plate (11), a movable plate (12) sliding relative to the fixed plate (11), and a magazine seat (13) rigidly connected to a bottom of the movable plate (12), a hook lock assembly (8) connects the fixed plate (11) with the magazine seat (13);
the magazine (1) has a push plate (6) disposed therein, a compression spring (7) is configured between the push plate (6) and the magazine seat (13) to continually push nails (5) towards the guide plate (2),
the guide plate (2) includes a separable first guide plate (21) and a second guide plate (22), the first guide plate (21) is connected to the fixed plate (11) via fasteners, and the second guide plate (22) is connected to the movable plate (12) via fasteners, a square hole (211) is disposed at a center of the first guide plate (21), and the second guide plate (22) has an integral nail splitter (221) which fits into the square hole (211) to form a nail groove (2a).

2. The optimized nail gun firing structure according to claim 1, wherein the hook lock assembly (8) includes a hook (81) pivotally connected to the magazine seat (13) and an elastic element (82) for resetting the hook (81), the hook (81) secures to the fixed plate (11) under the action of the elastic element (82).

3. The optimized nail gun firing structure according to claim 1, wherein the movable plate (12) includes an integrally formed partition plate (121), which forms a U-shaped groove (1a) in an interior cavity of the magazine (1), a top of the U-shaped groove (1a) connects to the nail groove (2a), and a cross-section of the push plate (6) is U-shaped to fit the U-shaped groove (1a).

4. The optimized nail gun firing structure according to claim 3, wherein the fixed plate (11) has a vertically oriented guide channel (111), and the push plate (6) has a protrusion (61) that extends into the guide channel (111).

5. The optimized nail gun firing structure according to claim 3, wherein an inner wall of the fixed plate (11) has multiple equally spaced first protrusions (112), and the partition plate (121) has multiple equally spaced second protrusions (122), the position of the second protrusions (122) corresponds to the first protrusions (112).

6. The optimized nail gun firing structure according to claim 1, wherein the cover assembly (4) includes a fixed seat (41) attached to one end of the first guide plate (21), a pressing plate (42) pivotally connected to the fixed seat (41), a latch (43) pivotally connected to a top of the pressing plate (42), and a spring hook (44) rotatably connected to the latch (43), the spring hook (44) secures to a hook portion (212) of the first guide plate (21) to apply pressure to the pressing plate (42) against the first guide plate (21).
